(19) United States
(12) Patent Application Publication
(10) Pub. No.: US 2012/0069604 A1
(43) Pub. Date: Mar. 22, 2012

(54) COMPACT POWER CONVERTER WITH HIGH EFFICIENCY IN OPERATION

(75) Inventors: Keisuke YAGYU, Kariya-shi (JP); Kazuhiro Umetani, Kariya-shi (JP)

(73) Assignee: DENSO CORPORATION, Kariya-city (JP)

(21) Appl. No.: 13/238,506

(22) Filed: Sep. 21, 2011

(30) Foreign Application Priority Data
Sep. 21, 2010 (JP) 2010-210478

(51) Int. Cl. H02M 3/335

(52) U.S. Cl. 363/20

(57) ABSTRACT

A power converter including a main circuit and a sub-circuit. The main circuit serves as a step-up/down chopper circuit including a series-connected assembly of main switches, an inductor coupled to a joint of the main switches, and a capacitor connected in parallel to the series-connected assembly. The sub-circuit is designed to establish the soft-switching and includes a snubber capacitor, a first sub-switch coupled to the joint of the series-connected assembly and a negative terminal of the snubber capacitor, a second sub-switch coupled to the joint and a positive terminal of the snubber capacitor, a third sub-switch coupled to the positive terminal of the snubber capacitor and a high-potential terminal of the main circuit, and a fourth sub-switch coupled to the negative terminal of the snubber capacitor and a low-potential terminal of the main circuit.

### CROSS REFERENCE TO RELATED DOCUMENT

The present application claims the benefit of priority of Japanese Patent Application No. 2010-210478 filed on Sep. 21, 2010, the disclosure of which is incorporated herein by reference.

### BACKGROUND OF THE INVENTION

1. Technical Field

The present invention relates generally to a power converter equipped with a first current flow controlling component which has an open/close function to open or close a current flow path and a second current flow controlling component which has at least one of the open/close function and a rectifying function to permit a flow of current only in one direction and is connected in series with the first current flow controlling component between a high-potential terminal and a low-potential terminal across which voltage is applied and an inductor coupled to a joint of the first and second current flow controlling components.

2. Background Art

Power converters equipped with an inductor are usually required to be reduced in size and have improved efficiency in operation thereof. These two requirements have a trade-off relationship. Specifically, the reduction in size of the power converter equipped with the inductor is usually achieved by increasing a switching frequency, but the increasing of the switching frequency will result in an increase in switching loss, which leads to a decrease in efficiency in operation of the power converter.

The high efficiency in operation of the power converter may be ensured without sacrificing the requirement to reduce the size by adding a few parts to the power converter for establishing the so-called soft-switching of switching devices of the power converter. For instance, the soft-switching may be achieved by connecting a capacitor in parallel between terminals of each of the switching devices to limit the voltage rise time upon switching from an on-state to an off-state of the switching device to the speed at which the voltage charged in the capacitor rises. This enables the switching devices to be operated in a zero-voltage switching (ZVS) mode. In the case where the capacitor is discharged when the switching devices are changed from the off-state to the on-state, a reduction in switching loss of the switching devices when changed to the off-state will be cancelled by that when changed to the on-state.

In order to alleviate the above problem, Japanese Patent First Publication No. 2006-296090 teaches a power converter which includes a regenerative inductor and a regenerative capacitor to return electrical energy which has been stored in snubber capacitors when switching devices were turned off to a power supply without discharging the snubber capacitors when the switching devices are turned on.

In the above prior art power converter, additional passive components directly contributing to the above described benefit of reduction in switching loss are only the snubber capacitors. Other additional passive components are used only to transfer electrostatic energy therebetween which has been stored in the snubber capacitors during the soft-switching to transmit it to the power supply using the resonance of the inductor and the capacitor. The use of the additional passive components, however, results in an increase in size of the power converter. This is because the size of the capacitors usually depends upon the capacity thereof required to store the electrostatic energy, and the size of the additional passive components are generally proportional to the capacity thereof required to store electromagnetic energy. The energy to be stored in the snubber capacitors is known to be proportional to the square of voltage charged therein, so that the size of the snubber capacitor is proportional to the square of voltage developed by the power supply. Since the energy stored in the snubber capacitors is temporarily transferred to the other passive components in the power converter, the size of these passive components is also proportional to the square of the power-supply voltage. In the power converter designed for high voltages, the size of the passive components occupies a significant portion of the power converter.

### SUMMARY

It is therefore an object to provide an improved structure of a power converter apparatus which is compact in size and high in efficiency in operation.

According to one aspect of an embodiment, there is provided a power converter apparatus which may be employed for transmission of electric power between a battery and an electric motor. The power converter apparatus comprises: (a) a high-potential terminal and a low-potential terminal of a converter circuit to which voltage is to be applied; (b) a first current flow controlling component which performs an open/close function to selectively open and close a current flow path extending between the high-potential terminal and the low-potential terminal; (c) a second current flow controlling component which is connected in series with the first current flow controlling component between the high-potential terminal and the low-potential terminal of the converter circuit, the second current flow controlling component performing one of an open/close function and a rectifying function, the open/close function being to selectively open and close the current flow path extending between the high-potential terminal and the low-potential terminal, the rectifying function being to permit an electrical current to flow in only one direction; (d) an inductor connected to a joint of the first current flow controlling component and the second current flow controlling component; (e) a capacitor disposed between the high-potential terminal and the low-potential terminal; and (f) a switching circuit which switches between a first connection state and a second connection state. The first connection state is to connect a first and a second terminal of the capacitor to a high-potential terminal and a low-potential terminal of the first current flow controlling component, respectively. The second connection state is to connect the first and the second terminal of the capacitor to a high-potential terminal and a low-potential terminal of the second current flow controlling component, respectively.

When the capacitor is electrically connected at ends thereof to the current flow path on opposed sides of the first current flow controlling component (i.e., the first connection state is entered), the rate of rise in voltage across the first current flow controlling component will be suppressed by the rate of rise in voltage at the capacitor when the first current flow controlling component is switched to the open state, thus establishing the soft-switching in the first current flow controlling component. When the charged capacitor is electrically connected in parallel to the second current flow controlling component (i.e., the second connection state is entered), the rate at which the voltage at the first current flow controlling component rises will be suppressed by the rate at which the capacitor is discharged upon switching of the first current flow controlling component from the closed state to the open state, thus establishing the soft-switching in the first current flow controlling component. Specifically, the structure of the power converter apparatus permits the energy which has been stored in the capacitor to achieve the soft-switching when the first current flow controlling component is opened to be used again in achieving the soft-switching when the first current flow controlling component is opened.

The switching circuit needs not be equipped with additional magnetic parts, thus permitting the size thereof to be reduced as well as improvement of efficiency in operation thereof.

In the preferred mode of the embodiment, the switching circuit works to switch among the first connection state, the second connection state, and a third connection state which does not place the capacitor in parallel connection with both the first and second current flow controlling components. In the case where the switching circuit is designed to switch only between the first and second connection states, it requires synchronization of such state switching with switching of the first current flow controlling component to the closed state, but the need for the synchronization will be eliminated by the third connection state.

The power converter apparatus may also include open/close operating means for opening and closing the first current flow controlling component in a cycle, and cyclic switching performing means for performing switching between the first and second connection states in every state switching cycle that corresponds to two cycles in each of which the first current flow controlling component is closed and opened sequentially. The cyclic switching performing means establishes the first connection state in a period of time in which the first current flow controlling component is placed in the closed state for the first time within the state switching cycle and also establishes the second connection state in a period of time in which the first current flow controlling component is placed in the closed state for the second time within the state switching cycle.

Specifically, the rate at which the voltage increases at the first current flow controlling component when brought into the open state is decreased by the rate at which the capacitor is discharged when the second connection state is established, and the capacitor is charged when the first current flow controlling component is switched to the open state in the first connection state.

Further, the cyclic switching performing means may also perform, in sequence, a first switching mode, a second switching mode, a third switching mode, and a fourth switching mode. The first switching mode is entered to establish the first connection state after the first current flow controlling component is placed in the closed state for the first time within the state switching cycle. The second switching mode is entered to establish the third connection state after the first current flow controlling component is placed in an open state for the first time within the state switching cycle. The third switching mode is entered to establish the second connection state after the first current flow controlling component is placed in the closed state for the second time within the state switching cycle. The fourth switching mode is entered to establish the third connection state after the first current flow controlling component is placed in the open state for the second time within the state switching cycle.

The power converter apparatus may also include capacitance varying means for varying a capacitance of the capacitor and capacitance controlling means for controlling an operation of the capacitance varying means to decrease the capacitance of the capacitor when an electrical current flowing through the inductor is smaller than a given value.

Leading the current through the second current flow controlling component when the first current flow controlling component is switched to the open state requires elevating the voltage at the high-potential terminal of the first current flow controlling component up to that at the high-potential terminal of the second current flow controlling component. The voltage at the high-potential terminal of the first current flow controlling component, however, depends upon the quantity of energy charged in or discharged from the capacitor. Therefore, when the current flowing through the inductor is small, it will cause the rate at which the voltage charged in the capacitor changes to drop, thus resulting in an increased time required for the current to flow to the second current flow controlling component or a failure in elevating the voltage at the high-potential terminal of the first current flow controlling component up to that at the high-potential terminal of the second current flow controlling component. This results in loss of the operation of the switching circuit. A decrease in capacitance of the capacitor, however, results in an excessive increase in rate at which the voltage charged in the capacitor changes when the current flowing through the inductor is great. This results in an undesirable increase in rate at which the voltage across the first current flow controlling component rises when the first current flow controlling component is switched to the open state, which leads to a difficulty in achieving the soft-switching in the first current flow controlling component.

In order to avoid the above problem, the power converter apparatus works to decrease the capacitance of the capacitor when the current flowing through the inductor is small, thereby ensuring the stability in achieving the soft-switching in the first current flow controlling component.

The cyclic switching performing means includes inhibiting means for inhibiting the first connection state from being entered while establishing the second connection state upon switching of the first current flow controlling component to the open state under condition that a voltage charged in the capacitor is greater than or equal to half a voltage developed between the high-potential terminal and the low-potential terminal of the converter circuit. The inhibiting means also inhibits the second connection state from being entered while establishing the first connection state upon switching of the first current flow controlling component to the open state when the voltage charged in the capacitor is smaller than half the voltage developed between the high-potential terminal and the low-potential terminal of the converter circuit.

Leading the current through the second current flow controlling component when the first current flow controlling component is switched to the open state requires elevating the voltage at the high-potential terminal of the first current flow controlling component up to that at the high-potential terminal of the second current flow controlling component. The voltage at the high-potential terminal of the first current flow controlling component, however, depends upon the quantity of energy charged in or discharged from the capacitor. Therefore, when the current flowing through the inductor is small, it may result in a difficulty in elevating the voltage at the high-potential terminal of the first current flow controlling component up to that at the high-potential terminal of the second current flow controlling component. In such an event, the cyclic repetition of the first connection state and the second connection state may result in lack in decreasing the loss of power.

In order to alleviate the above problem, the power converter apparatus inhibits the first connection state from being entered while establishing the second connection state upon switching of the first current flow controlling component to the open state when the voltage charged in the capacitor is greater than or equal to half a voltage developed between the high-potential terminal and the low-potential terminal of the converter circuit. This results in a decrease in rate at which the voltage across the first current flow controlling component rises when the first current flow controlling component is switched to the open state as compared with the case where the first connection state is permitted to be entered. The power converter apparatus also inhibits the second connection state from being entered while establishing the first connection state upon switching of the first current flow controlling component to the open state under condition that the voltage charged in the capacitor is smaller than half the voltage developed between the high-potential terminal and the low-potential terminal of the converter circuit. This result in a decrease in rate at which the voltage across the first current flow controlling component rises when the first current flow controlling component is switched to the open state as compared with the case where the second connection state is permitted to be entered.

The switching circuit may also include a first sub-current flow controlling component, a second sub-current flow controlling component, a third sub-current flow controlling component, and a fourth sub-current flow controlling component, each of which performs one of the open/close function and the rectifying function. The first sub-current flow controlling component is disposed between the joint of the first current flow controlling component and the second current flow controlling component and the second terminal of the capacitor. The second sub-current flow controlling component is disposed between the joint of the first current flow controlling component and the second current flow controlling component and the first terminal of the capacitor. The third sub-current flow controlling component is disposed between the first terminal of the capacitor and the high-potential terminal of the converter circuit. The fourth sub-current flow controlling component being disposed between the second terminal of the capacitor and the low-potential terminal of the converter circuit.

The converter circuit may be designed to output electric power from the inductor to the high-potential terminal thereof. The first and fourth sub-current flow controlling components may each have the open/close function. The second sub-current flow controlling component has the rectifying function to permit the current to flow only from the joint to the capacitor. The third sub-current flow controlling component has the rectifying function to permit the current to flow only from the first terminal of the capacitor to the high-potential terminal of the converter circuit The converter circuit may be designed to output no electric power from the high-potential terminal thereof to the inductor. The second sub-current flow controlling component and the third sub-current flow controlling component may each be implemented by a diode.

The converter circuit may alternatively be designed to output electric power from the high-potential terminal thereof to the inductor. The second and third sub-current flow controlling components may each have the open/close function. The first sub-current flow controlling component may have the rectifying function to permit the current to flow only from the capacitor to the joint. The fourth sub-current flow controlling component may have the rectifying function to permit the current to flow only from the low-potential terminal of the converter circuit to the second terminal of the capacitor. The converter circuit serves to output no electric power from the inductor to the high-potential terminal thereof. The first sub-current flow controlling component and the fourth sub-current flow controlling component are each implemented by a diode.

The converter circuit may serve to output electric power selectively from the high-potential terminal thereof to the inductor and from the inductor to the high-potential terminal thereof. Each of the first sub-current flow controlling component, the second sub-current flow controlling component, the third sub-current flow controlling component, and the fourth sub-current flow controlling component has the open/close function.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a circuit diagram which illustrates a converter control system for a power converter according to the first embodiment of the invention;

FIG. 2(a) to 2(d) are circuit diagrams which demonstrate connections of switches of the power converter of FIG. 1 to establish first to fourth operating states thereof;

FIG. 2(e) is a time chart which demonstrate a relation among an on/off sequence of a main switch, an operating state of a sub-circuit, and an operating state of the power converter of FIG. 1;

FIGS. 3(a) to 3(d) are circuit diagrams which demonstrate connections of switches of the power converter of FIG. 1 to establish fifth to eighth operating states thereof;

FIG. 3(e) is a time chart which demonstrate a relation among an on/off sequence of a main switch, an operating state of a sub-circuit, and an operating state of the power converter of FIG. 1;

FIG. 4 is a table representing a relation among operating states of a main circuit, a sub-circuit, and switches, and flows of current in the main and sub-circuits of the converter of FIG. 1;

FIG. 5 is a circuit diagram which illustrates a converter control system for a power converter according to the second embodiment of the invention;

FIG. 6 is a flowchart of a program to be executed to change a total capacitance of snubber capacitors in the power converter of FIG. 5;

FIG. 7 is a circuit diagram which illustrates a converter control system for a power converter according to the third embodiment of the invention;

FIG. 8 is a flowchart of a program to be executed to change a total capacitance of snubber capacitors according to the fourth embodiment of the invention;

FIG. 9 is a circuit diagram which illustrates a converter control system for a power converter according to the fifth embodiment of the invention;

FIG. 10 is a circuit diagram which illustrates a converter control system for a power converter according to the sixth embodiment of the invention;

FIG. 11 is a circuit diagram which illustrates a converter control system for a power converter according to the seventh embodiment of the invention;

FIG. 12 is a circuit diagram which illustrates a converter control system for a power converter according to the eighth embodiment of the invention;

FIG. 13 is a circuit diagram which illustrates a converter control system for a power converter according to the ninth embodiment of the invention;

FIG. 14 is a circuit diagram which illustrates a converter control system for a power converter according to the tenth embodiment of the invention;

FIG. 15 is a circuit diagram which illustrates a converter control system for a power converter according to the eleventh embodiment of the invention; and

FIG. 16 is a circuit diagram which illustrates a converter control system for a power converter according to the twelfth embodiment of the invention.

### DESCRIPTION OF THE PREFERRED EMBODIMENTS

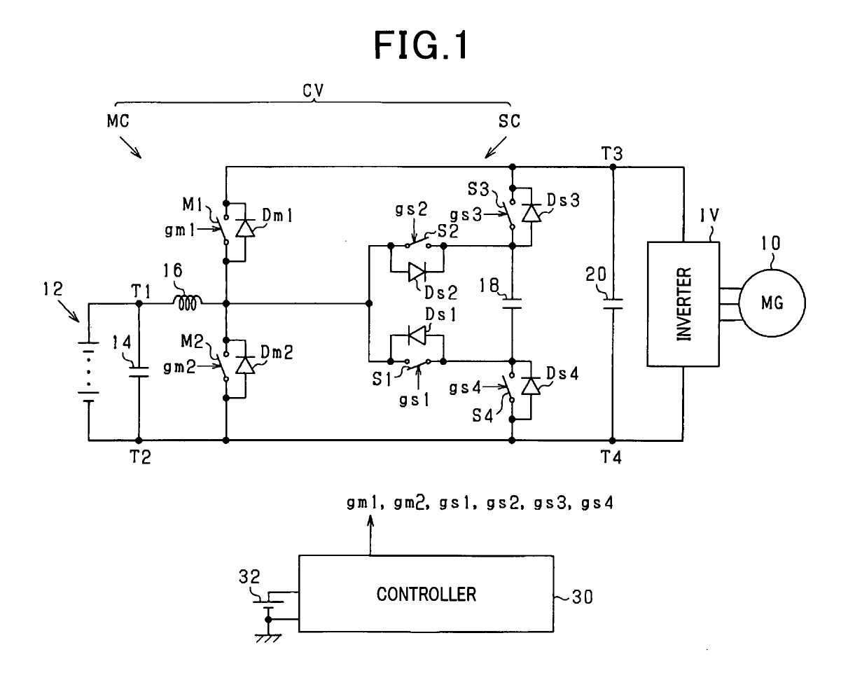

Referring to the drawings, wherein like reference numbers refer to like parts in several views, particularly to FIG. 1, there is shown a converter control system designed to control an operation of a power converter CV according to the first embodiment which is used in driving an main engine mounted in an automotive vehicle.

A motor-generator 10 is used as the main engine of the vehicle and has an output shaft (i.e., a rotating shaft) connected mechanically to driven wheels of the vehicle. The motor-generator 10 is joined electrically to a high-voltage battery 12 and a capacitor 14 through an DC-AC converter an inverter IV) and the converter CV. The high-voltage battery 12 is a secondary cell (also called a storage battery) whose terminal voltage is higher than one hundred volts.

The converter CV is equipped with a typical chopper circuit as a main circuit MC. The main MC consists essentially of a series-connected assembly of main switches M1 and M2, an inductor 16 connecting between a joint of the main switches M1 and M2 and the high-voltage battery 12, a capacitor 20 connected in parallel to the series-connected assembly, a diode Dm1 disposed in inverse-parallel connection (also called back-to-back connection) to the main switch M1, and a diode Dm2 disposed in inverse-parallel connection to the main switch M2. Each of the main switches M1 and M2 is implemented by an insulated gate bipolar transistor is (IGBT) or a power MOS field-effect transistor. In the case where the main switches M1 and M2 are the field-effect transistors, the diodes Dm1 and Dm2 may be provided by parasitic diodes of the transistors.

The converter CV is also equipped with a sub-circuit SC working to achieve a zero-voltage switching operation of the main switch M1 and M2 when turned off. The sub-circuit SC includes a snubber capacitor 18, a sub-switch S1 working to open or close a connection between the joint of the main switches M1 and M2 and a negative terminal of the snubber capacitor 18, and a sub-switch S2 working to open or close a connection between the joint of the main switches M1 and M2 and a positive terminal of the snubber capacitor 18. The sub-circuit SC also includes a sub-switch S3 working to open or close a connection between the positive terminal of the snubber capacitor 18 and a high-potential terminal of the converter CV and a sub-switch S4 working to open or close a connection between the negative terminal of the snubber capacitor 18 and a low-potential terminal of the converter CV. The sub-switches S1 to S4 are each implemented by the IGBT or the power MOS field-effect transistors. The snubber capacitor 18 needs not necessarily to have polarities. The terminal of the snubber capacitor 18 which is to be connected by the sub-switch S4 to the low-potential terminal of the converter CV is defined herein as the negative terminal.

A diode Ds1 in which the forward direction is a direction in which electric current is allowed to flow from the negative terminal of the snubber capacitor 18 to the joint of the main switches M1 and M2 is connected to the sub-switch S1. A diode Ds2 in which the forward direction is a direction in which electric current is allowed to flow from the joint of the main switches M1 and M2 to the positive terminal of the snubber capacitor 18 is connected to the sub-switch S2. A diode Ds3 is disposed in inverse parallel connection to the sub-switch S3. Similarly, a diode Ds4 is disposed in inverse parallel connection to the sub-switch S4. In the case where the sub-switches S1, S2, S3, and S4 are made of field-effect transistors, the diodes Ds1, Ds2, Ds3, and Ds4 may be implemented by parasitic diodes of the transistors.

The converter control system also includes a controller 30 which is powered by a low-voltage battery 32 whose terminal voltage is, for example, several volts to tens of volts. The controller 30 controls operations of the inverter IV and the converter CV to control an operation of the motor-generator 10. Specifically, the controller 30 regulates an output voltage of the converter CV. More specifically, the controller 30 outputs operation signals gm1 and gm2 to the main switches M1 and M2 and operation signals gs1, gs2, gs3, and gs4 to the sub-switches S1 to S4. The converter CV serves as a vehicle-mounted high-voltage system which is electrically isolated from a vehicle-mounted low-voltage system equipped with the controller 30. The operation signals gm1, gm2, gs1, gs2, gs3, and gs4 are, therefore, inputted to the converter CV through an insulator (not shown).

The following discussion will be made under the assumption that the converter CV serves as a step-up chopper circuit to step up the voltage outputted from the high-voltage battery 12. The stepping-up of the voltage is basically achieved by controlling an on/off operation of the main switch M2, however, the controller 30 of this embodiment turns on the main switch M1 and M2 alternately in a complementary drive mode. In the case where the main switch M1 is made of, for example, the field-effect transistor and functions to allow the electric current to flow in either direction, turning on of the main switch M1 will cause the electric current to flow through the main switch M1. Alternatively, in the case where the main switch M1 is made of, for example, the IGBT and functions to allow the electric current to flow in one direction, turning on of the main switch M1 will cause the electric current to flow through the diode Ds1.

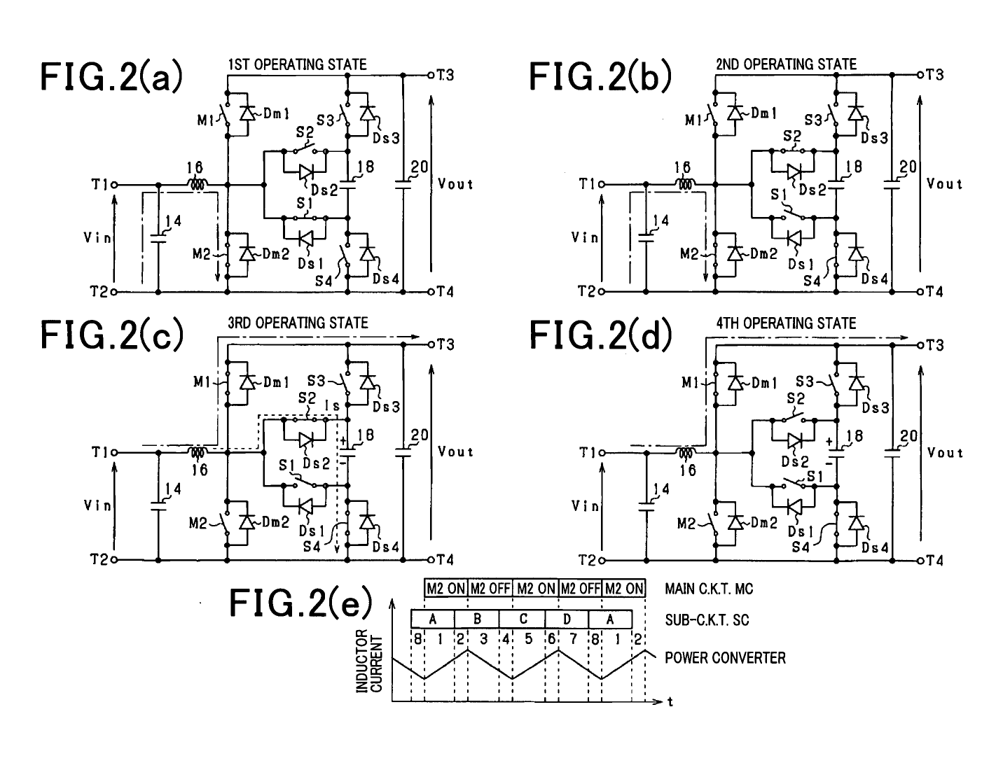

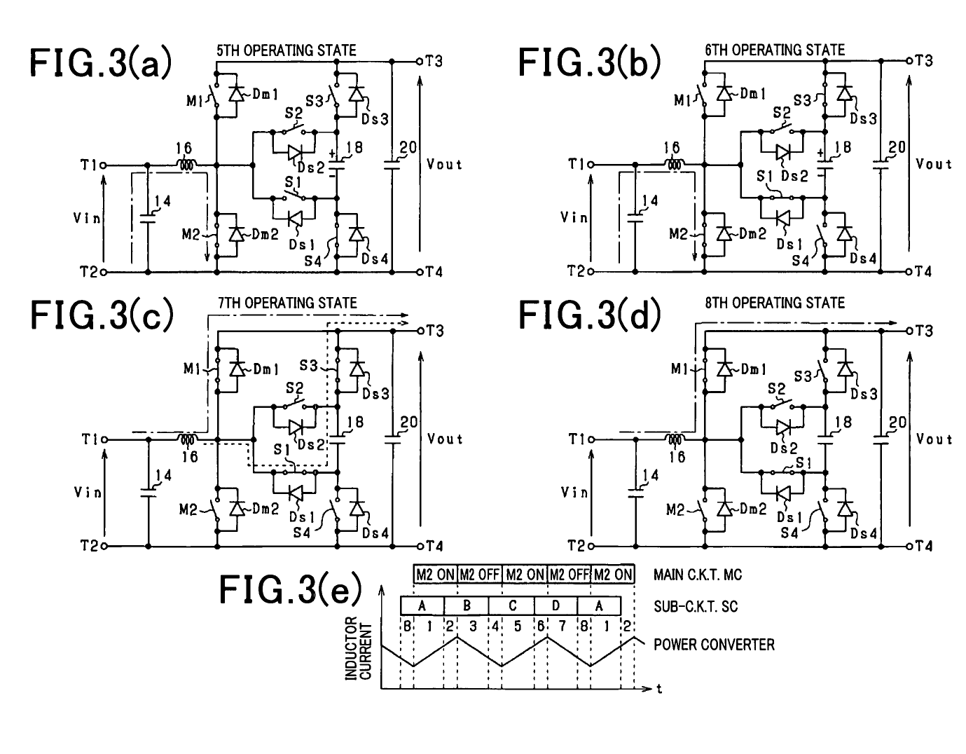

FIGS. 2(a) to 2(e) demonstrate the step-up operation of the converter CV Two consecutive on/off cycles, as illustrated in FIG. 2(e), in each of which the main switch M2 is turned on and off sequentially correspond to one operation cycle of the sub-circuit SC. “A” to “D” in FIG. 2(e) represent operating states of the sub-circuit SC and will be described later in detail. In each operating cycle, the sub-circuit SC is placed in first to eighth operating states, as established by possible combinations of operations of the sub-switches S1 to S4. The first to eighth operating states will be described below with reference to FIGS. 2(a) to 2(d) and FIGS. 3(a) to 3(d).

### 1^{st} Operating State

The main switch M2 is turned on, so that a condition where the current, as outputted from the inductor 16, flows the diode Dm1 (i.e., the main switch M1) is changed to a condition where the current flows to the main switch M2. The sub-circuit SC is placed in the operating state A where the snubber capacitor 18 is not connected in parallel to both the main switches M1 and M2.

### 2^{st} Operating State

The sub-switches S2 and S4 are turned on, so that the snubber capacitor 18 is connected in parallel to the main switch M2. This condition corresponds to the operating state B of the sub-circuit SC The electric charge is not stored in the snubber capacitor 18. No electric current, therefore, flows through the sub-switches S2 and S4 when turned on. This results in no switching loss in the sub-switches S2 and S4.

### 3^{rd} Operating State

The main switch M2 is turned off. This causes the current which has been outputted from the inductor 16 to the main switch M2 to flow into the snubber capacitor 18 through the diode Ds2 (i.e., the sub-switch S2). The voltage charged in the snubber capacitor 18 will be an output voltage of the converter CV (i.e., the voltage developed between the terminals of the capacitor 20), so that the current flowing through the inductor 16 is delivered to the capacitor 20 through the diode Dm1 (i.e., the main switch M1).

The rate at which the voltage between the high-potential and low potential terminals of the main switch M2 rises when the main switch M2 is turned off is restricted by the rate at which the voltage charged in the snubber capacitor 18 rises. The main switch M2, therefore, experiences the zero-voltage switching (ZVS) when turned off. The surge occurs in a circuit path through which no current flows when the main switch M2 is turned off. However, when the zero-voltage switching takes place in the main switch M2 when turned off, the voltage, as developed between the high-potential and low-potential terminals of the main switch M2, will be about the surge voltage caused by a parasitic inductor and is much smaller as compared with the case of the hard switching where the voltage equivalent to the output voltage of the converter CV is added to the surge voltage.

### 4^{th} Operating State

The sub-switch S2 is turned off to disconnect the snubber capacitor 18 from both the main switches M1 and M2. This condition corresponds to the operating state C of the sub-circuit SC.

### 5^{th} Operating State

The main switch M2 is, as illustrated in FIG. 3(a), turned on to change a current flow path through which the current, as outputted from the inductor 16, flows and which is equipped with the diode Dm1 (i.e., the main switch M1) to that which is equipped with the main switch M2. Specifically, the flow of current, as outputted from the inductor 16, is changed to the main switch M2. The turning on of the main switch M2 is made when the sub-circuit SC is in the operating state C, so that the snubber capacitor 18 does not discharge.

### 6^{th} Operating State

The sub-switches S1 and S3 are turned on to connect the snubber capacitor 18 parallel to the main switch M1. This condition corresponds to the operating state D of the sub-circuit SC. The voltage of the capacitor 18 will be equal to the output voltage of the converter CV, so that no electric current flows through the sub-switches S1 and S3 when turned on. This results in no switching loss in the sub-switches S1 and S3.

### 7^{th} Operating State

The main switch M2 is turned off. This causes the current, as outputted from the inductor 16 to flow to the capacitor 20 through the sub-switch S1, the snubber capacitor 18, the diode Ds3 (i.e., the sub-switch S3). The rate at which the voltage between the high-potential and low-potential terminals of the main switch M2 rises upon the turning off of the main switch M2 is restricted or suppressed by the rate at which the voltage charged in the snubber capacitor 18 drops (i.e., the rate at which the snubber capacitor 18 is discharged). The main switch M2, therefore, experiences the zero-voltage switching (ZVS) when turned off.

### 8^{th} Operating State

The snubber capacitor 18 is not connected parallel to both the main switches M1 and M2. This condition corresponds to the operating state A of the sub-circuit SC.

In the first to eighth operating states, when turned off, the main switch M2 experiences the zero-voltage switching. When the main switch M2 is turned on, the sub-circuit SC is placed in the operating state A or C, thereby avoiding the conversion of electrical energy charged in the snubber capacitor 18 into thermal energy in the main switch M2. The current flows into the sub-switches S1 to S4 only when the snubber capacitor 18 is charged or discharged, thus resulting in no switching loss therein. The quantity of heat generated by the sub-switches S1 to S4 will be smaller than that generated by the main switches M1 and M2. This permits the sub-switches S1 to S4 to be reduced in size.

The sub-circuit SC is equipped with no magnetic parts, but only with the snubber capacitor 18 as a passive component, thus facilitating the ease of reducing the size of the sub-circuit SC.

The time when the operating state A or C is to be switched from another state may be selected freely as long as it is prior to turning on of the main switch M2 (i.e., the main switch M2 is in the off-state). The time when the operating state B or D is to be switched from another state may be selected freely as long as it is prior to turning off of the main switch M2 (i.e., the main switch M2 is in the on-state). This eliminates the needs for performing the switching operation on the sub-switches S1 to S4 at high speeds and also for finely controlling the time when the sub-switches S1 to 34 to be turned on or off.

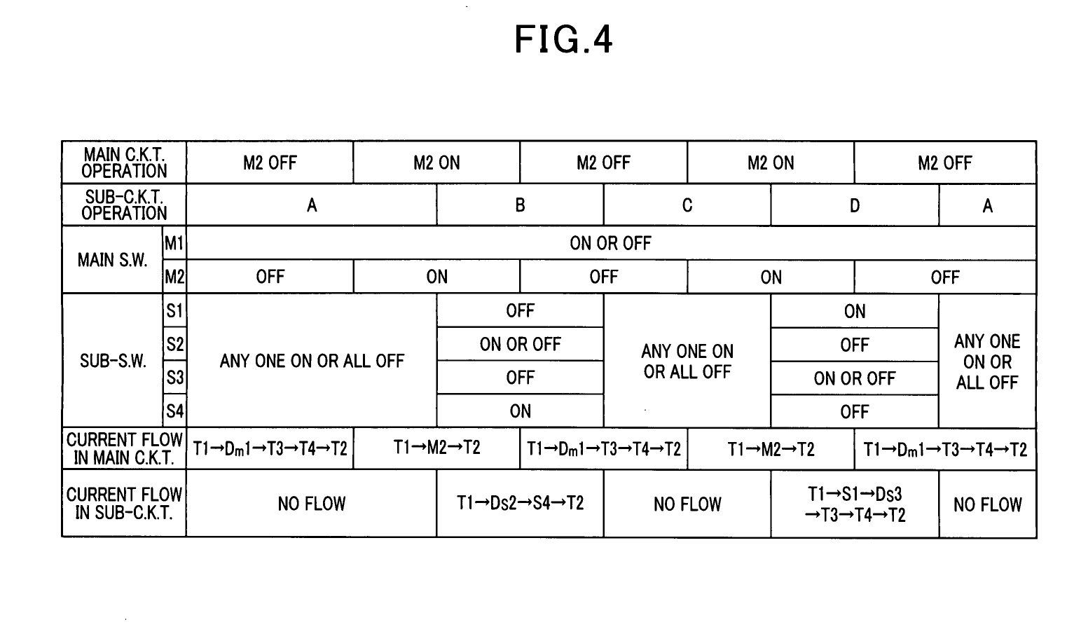

Combinations of the on/off states the sub-switches S1 to S4 may be other than the ones, as illustrated in FIGS. 2(a) to 2(d) and FIGS. 3(a) to 3(d), as long as they bring the sub-circuit SC into a required one of the operating states A to D. FIG. 4 illustrates possible combinations of the on/off states of the sub-switches S1 to 24. The turning on of the sub-switches S1 and S2, and the turning off of the sub-switches S3 and S4 when the sub-circuit SC is in the operating state A of FIG. 4 are possibly made when the amount of energy charged in the snubber capacitor 18 is expected to be small, thus resulting in a decrease in switching loss of the sub-switches S1 and S2. The turning off of the sub-switches S1 and S2, and the turning on of the sub-switches S3 and S4 when the sub-circuit SC is in the operating state C of FIG. 4 are possibly made when the amount of energy charged in the snubber capacitor 18 is expected to be great, thus resulting in a decrease in switching loss of the sub-switches S3 and S4.

The converter CV of this embodiment may work to turn on or off the main switch M1 to step-down and output he voltage at the capacitor 20 to the high-voltage battery 12 in an energy recovery mode. The switching of the operation of the sub-circuit SC among the operating states A to D in the energy recovery mode is achieved by interchanging the on/off operation of the main switch M2 with that of the main switch M1 and the on/off operations of the sub-switches S2 and S4 with those of the sub-switches S1 and S3 in the above power running mode. Specifically, the operating state B of the sub-circuit SC is established by turning on the sub-switches S1 and S3. The operating state D of the sub-circuit SC is established by turning on the sub-switches S2 and S4. This achieves the zero-voltage switching in the main switch M1 when turned off.

The power converter control system of the first embodiment offers the following beneficial advantages.

1) The converter CV is designed that the operating state where the snubber capacitor 18 is connected in parallel to the terminals (i.e., the source and the drain or the collector and the emitter) of the main switch M2 is permitted to be interchanged with that where the snubber capacitor 18 is connected in parallel to the terminals of the main switch M1, thus causing the rate of rise in voltage across the terminals of the main switch M1 or M2 to be suppressed by the rate at which the snubber capacitor 18 is charged when the main switch M1 or M2 is turned off and also be suppressed by the rate at which the snubber capacitor 18 is discharged when each of the main switch M1 or M2 is turned off in a subsequent on/off cycle.
2) The converter CV is designed to permit the snubber capacitor 18 not to be connected in parallel to the main switches M1 and M2. This eliminates the need for finely controlling the time when the operating state of the sub-circuit SC is to be changed.

The converter control system of the second embodiment will be described below.

In the converter control system of the first embodiment, when the electrical energy charged in the inductor 16 in the power running made is not greater than that in the snubber capacitor 18 charged until the output voltage Vout of the converter CV, it is impossible to make the electric current flow through the diode Dm1 (i.e., the main switch M1) in the operating state B. In this condition, the switching loss occurs when the operating states of the sub-switches S1 and S3 are changed to connect the snubber capacitor 18 parallel to the main switch M1.

The energy to be charged in the snubber capacitor 18 is proportional to an electrostatic capacity or capacitance thereof and thus may be made to be smaller than the energy to be charged in the inductor 16 by decreasing the capacitance of the snubber capacitor 18. When the energy of the inductor 16 is much great, such decreasing of the capacitance, however, results in an increased rate of change in voltage charged in the capacitor 18, which will lead to an increased rate of rise in voltage appearing across the terminals of the main switch M2 when turned off. This makes it impossible to achieve the soft-switching in the main switch M2 when turned off. Accordingly, when the quantity of energy stored in the inductor 16 is to be changed greatly, it is difficult or impossible for the snubber capacitor 18 to have a capacitance required in an overall range of the energy in the inductor 16.

The converter CV of the second embodiment is, thus, designed to change the capacitance of the snubber capacitor 18 as a function of the amount of electric current flowing through the inductor 16.

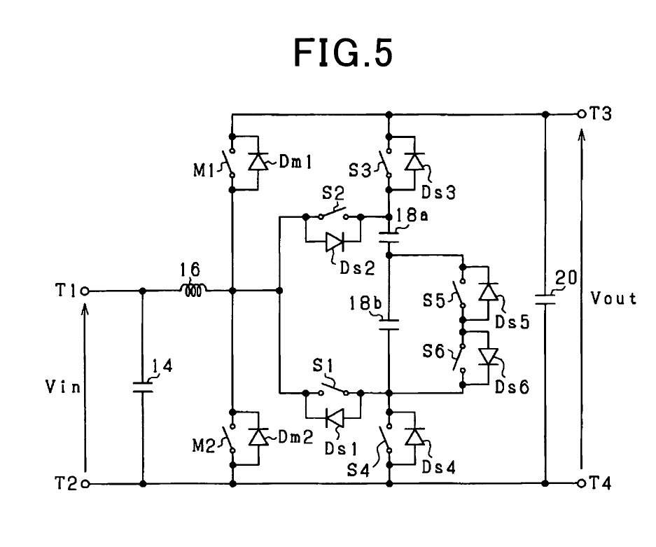

FIG. 5 illustrates a circuit structure of the converter CV of the second embodiment. The same reference numbers as employed in the first embodiment refer to the same parts, and explanation thereof in detail will be omitted here.

The converter CV has two snubber capacitors 18a and 18b connected in series with each other and a circuit path which extends from one terminal to another of the snubber capacitor 18b in parallel thereto through the sub-switches S5 and S6 (which will also be referred to as a bypass path below). The sub-switches S5 and S6 are made of the IGBT or the power MOS field-effect transistor. The diodes Ds5 and Ds6 are, therefore, connected in inverse-parallel to the sub-switches S5 and S6, respectively. In the case of the IGBT, the diodes Ds5 and Ds6 serve to protect the sub-switches S5 and S6. Alternatively, in the case of the field-effect transistor, the diodes Ds5 and Ds6 are implemented by body diodes. In the case where the sub-switches S5 and S6 are made of the field-effect transistor, opening the bypass path requires blocking a circuit path extending through the diodes Ds5 and Ds6 connected in inverse-parallel to the sub-switches S5 and S6. In the case where the sub-switches S5 and S6 are made of the IGBT, it is necessary to permit the current to flow in both directions. These are reasons why the bypass path is made using the sub-switches S5 and S6. The diodes Ds5 and Ds6 are illustrated as being connected at anodes thereof to each other, but may be connected at cathodes thereof to each other.

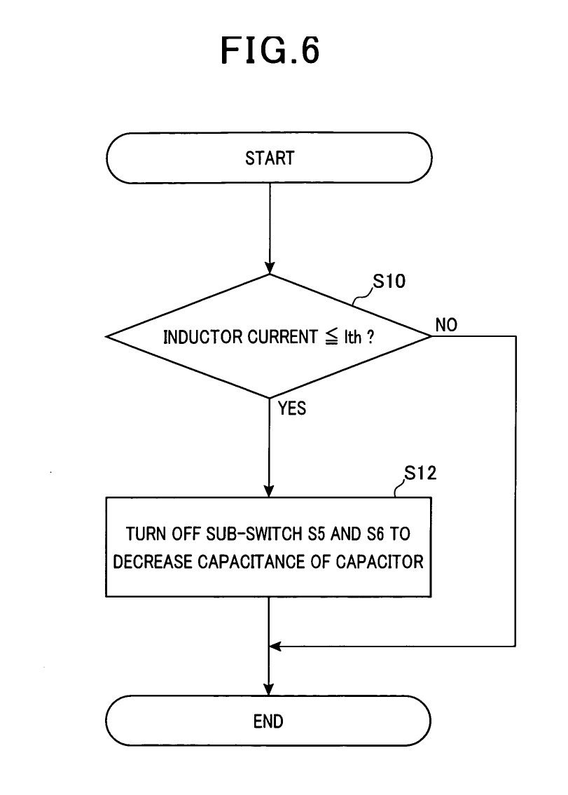

FIG. 6 is a flowchart of a sequence of logical steps or program to be executed by the controller 30 to change the total capacitance of the snubber capacitors 18a and 18b as a function of the amount of electric current flowing through the inductor 16. The program is to be executed at a regular interval.

After entering the program, the routine proceeds to step S10 wherein it is determined whether the electric current flowing through the inductor 16 is lower than or equal to a given threshold value Ith or not. The current flowing through the inductor 16 may be measured using a current sensor or mathematically calculated based on a ratio of an on-time of the main switch M2 or M1 to an on-to-off time in which the main switch M2 or M1 is turned on and off sequentially. The threshold value Ith is so selected that a ratio of the quantity of electric charge charged in the snubber capacitor 18a for a given charging time period Ta when the threshold value Ith of current flows through the inductor 16 to the quantity of electric charge in the snubber capacitor 18a when the voltage charged in the snubber capacitor 18a reaches the output voltage Vout of the converter CV may be a given ratio a. Specifically, the threshold value Ith is given by a relation of Ith=a·Qc/Tc where Qc is the quantity of charge in the snubber capacitor 18a when charged fully, the charging time period Tc for which the snubber capacitor 18a is charged, and a is the above charged ratio. The charging time period Tc is a time interval between when the main switch M2 is turned off and when the fourth or eighth state is entered. The product of the charging time period Tc and the threshold value Ith represents the quantity of charge in the snubber capacitor 18a. The charged ratio a is preferably set to 0.8 or more, more preferably 1.0 or more.

If a YES answer is obtained in step S10 meaning that the electric current flowing through the inductor 16 is lower than or equal to the threshold value Ith, then the routine proceeds to step S12 wherein the sub-switches S5 and S6 are turned off to decrease a total capacitance of the snubber capacitors 18a and 18b. If a NO answer is obtained in step S10 or after step S12, the routine terminates.

The power converter control system of the second embodiment offers an additional beneficial advantage below in addition to the advantages 1) and 2).

3) When the current flowing through the inductor 16 is small, the converter control system decreases the total capacitance of the snubber capacitors 18a and 18b, thus ensuring the soft-switching in the main switch M2.

The converter control system of the third embodiment will be described below which is a modification of the second embodiment.

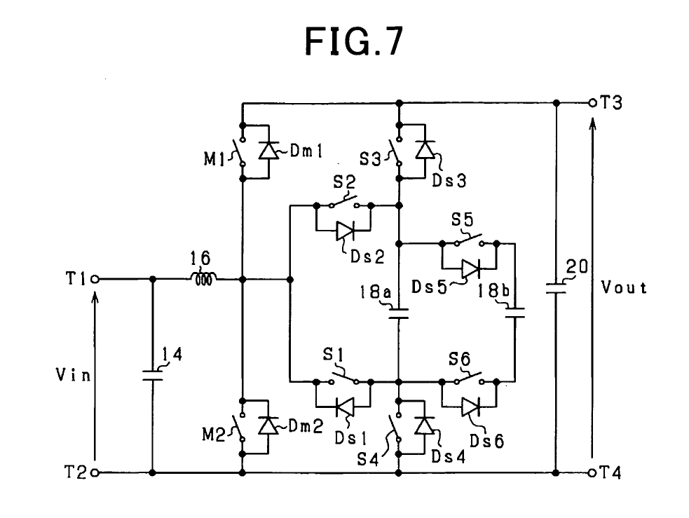

FIG. 7 shows a converter CV of the third embodiment. The same reference numbers as employed in the first and second embodiments refer to the same parts, and explanation thereof in detail will be omitted here.

The converter CV has the snubber capacitors 18a and 18b connected in parallel to each other and the sub-switches S5 and S6 connected in parallel to each other. Specifically, the sub-switches S5 and S6 are disposed between the snubber capacitors 18a and 18b so as to establish the parallel connection of the snubber capacitors 18a and 18b. The reason for use of the two sub-switches S5 and S6 is the same as in the second embodiment. The sub-switches S5 and S6 in this embodiment are each made of the field-effect transistor which allows the electric current to flow in either direction. Each of the diodes Ds5 and. Ds6 is connected at the anode thereof to the snubber capacitor 18a, but may alternatively be connected to the snubber capacitor 18b. The sub-switches S5 and S6 may alternatively be coupled with the positive terminals or the negative terminals of the snubber capacitors 18a and 18b, while the diodes Ds5 and Ds6 may be joined at the anodes or cathodes thereof to each other.

Like in the second embodiment, when the current flowing through the inductor 16 is lower than or equal to the threshold value Ith, the controller 30 turns off or opens the sub-switches S5 and S6 to decrease the total capacitance of the snubber capacitors 18a and 18b.

The converter control system of the fourth embodiment will be described below which is a modification of the first embodiment. The converter CV of this embodiment is identical in structure with the one of the first embodiment,

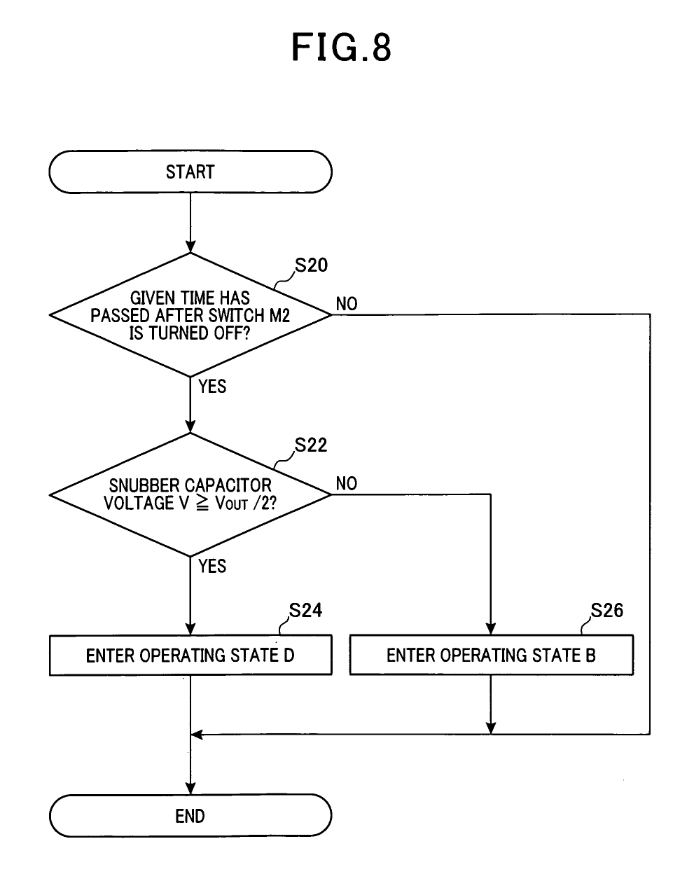

FIG. 8 is a flowchart of a sequence of logical steps or program to be executed by the controller 30 of the converter control system of the fourth embodiment to control operations of the sub-circuit SC during the power running mode of the converter CV which include a special operation, as described below, to be executed when the current flowing through the inductor 16 is small. The program is to be executed at a regular interval.

After entering the program, the routine proceeds to step S20 wherein it is determined whether a given period of time has passed or not after the main switch M2 is turned off. This determination is made for determining whether the time when the operating state B or D is to be entered has been reached or not. The given period of time is preferably selected to be longer than or equal to the time required for the main switch M2 to be turned on in response to the on-signal from the controller 30. If a YES answer is obtained, then the routine proceeds to step S22 wherein it is determined whether the voltage V appearing at the snubber capacitor 18 is greater than or equal to half the output voltage Vout of the converter CV or not. This determination is made for determining whether a reduction in switching loss, as derived in the main switch M2 when turned off in the case where the snubber capacitor 18 is connected in parallel to the main switch M2, is greater than that, as derived in the main switch M2 when turned off in the case where the snubber capacitor 18 is connected in parallel to the main switch M1, or not. Specifically, when the voltage V charged in the snubber capacitor 18 is greater than or equal to half the output voltage Vout (i.e., Vout/2), the parallel connection of the snubber capacitor 18 to the main switch M2 causes the voltage which is at least greater than or equal to Vout/2 to be applied across the high-potential and low-potential terminals of the main switch M2 when turned off, but the parallel connection of the snubber capacitor 18 to the main switch M1 causes the voltage applied across the high-potential and low-potential terminals of the main switch M2 when turned off to be lower than Vout/2.

If a YES answer is obtained in step S22 meaning that the parallel connection of the snubber capacitor 18 to the main switch M1 results in a greater reduction in the switching loss, then the routine proceeds to step S24 wherein it is determined that the operating state D is to be established. Alternatively, if a NO answer is obtained meaning that the parallel connection of the snubber capacitor 18 to the main switch M2 results in a greater reduction in the switching loss, then the routine proceeds to step S26 wherein it is determined that the operating state B is to be established.

In the case of the operating state D, when the voltage V at the snubber capacitor 18 is smaller than the output voltage Vout or smaller than the output voltage Vout by a given level, the time when the parallel connection of the snubber capacitor 18 to the main switch M1 is to be achieved is preferably synchronized with that when the main switch M2 is to be turned off. In the case of the operating state B, when the voltage Vat the snubber capacitor 18 is greater than zero or greater than zero by a given level, the time when the parallel connection of the snubber capacitor 18 to the main switch M2 is to be achieved is preferably synchronized with that when the main switch M2 is to be turned off.

The power converter control system of the fourth embodiment offers an additional beneficial advantage below in addition to the advantages 1), 2), and 3).

4) The determination of whether the sub-circuit SC is to be placed in the operating state B or D is made based on the voltage Vat the snubber capacitor 18, thereby ensuring the reduction in switching loss in the main switches M1 and M2 when turned off even when the current flowing through the inductor 16 is small.

The converter control system of the fifth embodiment will be described below which is a modification of the first embodiment.

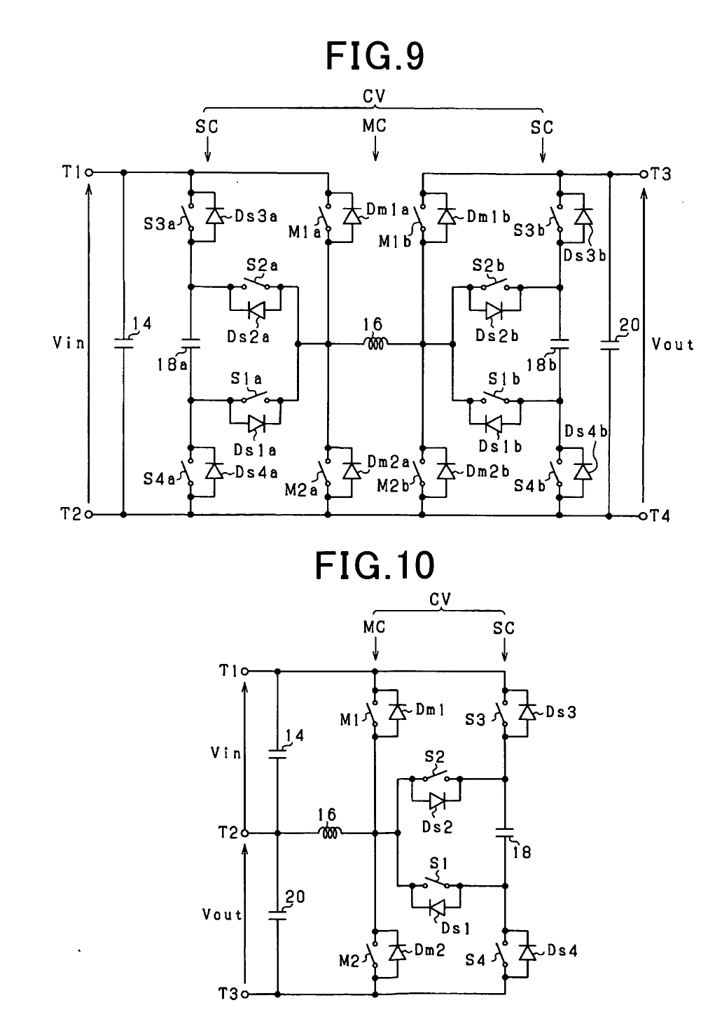

FIG. 9 shows a converter CV of the fifth embodiment. The same reference numbers as employed in the above embodiments refer to the same parts, and explanation thereof in detail will be omitted here.

The main circuit MC of the converter CV of this embodiment works as a step-up/down converter to change an output voltage over a range of a level lower than an input voltage to a level higher than the input voltage. The converter CV includes a series-connected assembly of main switches M1a and M2a connected in parallel to input terminals T1 and T2 of the converter CV (i.e., terminals of the capacitor 14), a series-connected assembly of main switches M1b and M2b connected in parallel to output terminals T3 and T4 of the converter CV(i.e., terminals of the capacitor 20), and the inductor 16 connecting joints between the main switches M1a and M2a and between the main switches M1b and M2b. The converter CV also has diodes Dm1a, Dm2a, Dm1b, and Dm2b connected in inverse-parallel to the main switches M1a, M2a, M1b, and M2b, respectively.

In the power running mode, the main circuit MC turns on the main switches M1a and M2b to charge the electric energy in the inductor 16 and then turns them off to output the energy, as stored in the inductor 16, to the capacitor 20. In the energy recovery mode, the main circuit MC turns on the main switches M2a and M1b to charge the electric energy in the inductor 16 and then turns off them to output the energy, as stored in the inductor 16, to the capacitor 14.

The converter CV also includes two sub-circuits SC which will also be referred to as a first sub-circuit SC and a second sub-circuit SC below. The first sub-circuit SC is equipped with a snubber capacitor 18a and sub-switches S1a to S4a which are connected to the main circuits M1a and M2a. Similarly, the second sub-circuit SC is equipped with a snubber capacitor 18b and sub-switches S1b to S4b which are connected to the main circuits M1b and M2b. The operational relations of the main switches Mia and M2a to the sub-switches S1a to S4a and the operational relations of the main switches M1b and M2b to the sub-switches S1b to S4b are identical with those of the main switch M1 and M2 to the sub-switches S1 to S4 in the first embodiment

The sub-switches S1a to S4a are disposed in inverse-connection with the diodes D1a to D4a, respectively. Similarly, the sub-switches S1b to S4b are disposed in inverse-connection with the diodes Ds1b to Ds4b, respectively.

The converter control system of the sixth embodiment will be described below which is a modification of the first embodiment.

FIG. 10 shows a converter CV of the sixth embodiment. The same reference numbers as employed in the above embodiments refer to the same parts, and explanation thereof in detail will be omitted here.

The main circuit MC of the converter CV works as a step-up/down converter to change an output voltage (i.e., the voltage at the capacitor 20) so as to be opposite in sign to that of an input voltage (i.e., the voltage at the capacitor 14) and also change an absolute value of the output voltage over a range of a level lower than the input voltage to a level higher than the input voltage. The converter CV includes a series-connected assembly of the main switches M1 and M2, the inductor 16 connected to a joint of the main switches M1 and M2, and the capacitor 20 connected in parallel to the main switch M2 through the inductor 16. The input terminals T1 and T2 of the converter SC (i.e., the terminals of the capacitor 14) are connected in parallel to the main switch M1 through the inductor 16. The diodes Dm1 and Dm2 are disposed in inverse-connection to the main switches M1 and M2, respectively.

In the power running made, the main circuit MC turns off the main switch M1 to charge the electric energy in the inductor 16 and then turns it off to output the energy, as stored in the inductor 16, to the capacitor 20. In the energy recovery mode, the main circuit MC turns on the main switch M2 to charge the electric energy in the inductor 16 and then turns it off to output the energy, as stored in the inductor 16, to the capacitor 14.

The sub-circuit SC of the converter CV also includes the sub-switches S1 to S4 and the snubber capacitor 18 in order to achieve the soft-switching in the main switches M1 and M2 when turned off. The operational relations of the main switches M1 and M2 to the sub-switches S1 to S4 are identical with those in the first embodiment, and explanation thereof in detail will be emitted here.

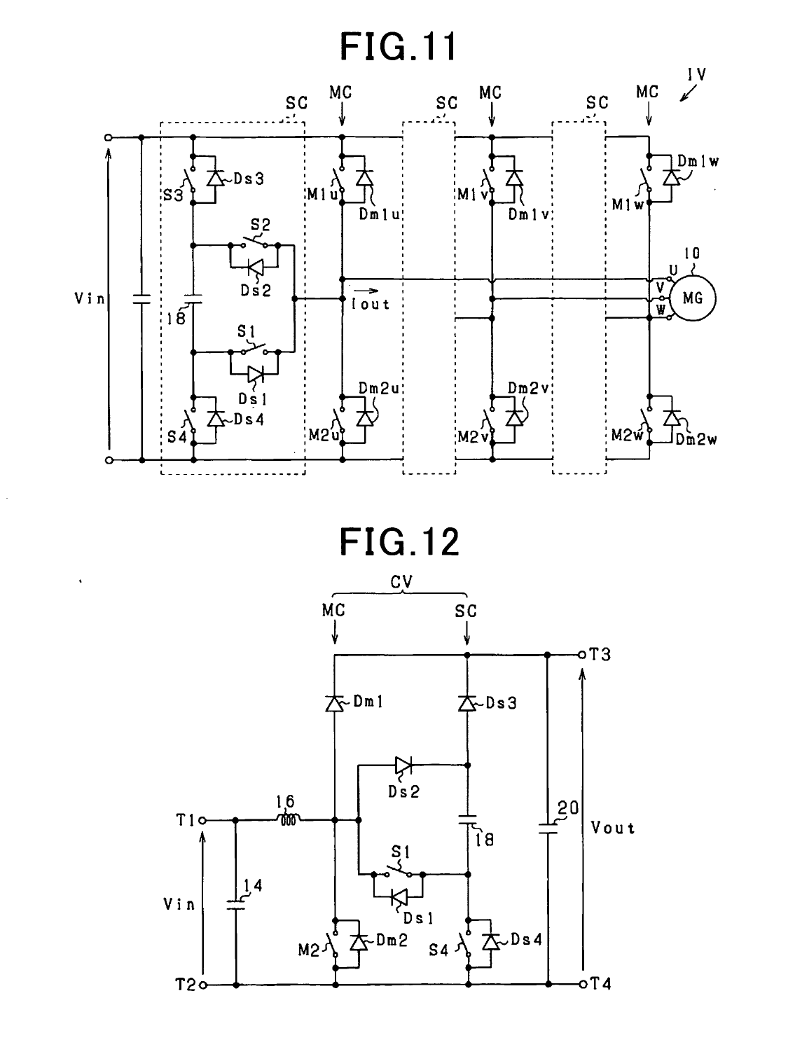

The converter control system of the seventh embodiment will be described below with reference to FIG. 11 which is a modification of the first embodiment.

The converter control system includes an inverter IV made up of three main circuits MC and three sub-circuits SC to control the operation of the motor-generator 10. The main circuits MC respectively include a series-connected assembly of main switches M1u and M2u, a series-connected assembly of main switches M1v and M2v, and a series-connected assembly of main switches M1w arid M2w. The motor-generator 10 is a three-phase motor-generator equipped with a U-phase winding, a V-phase winding, and a W-phase winding. The main circuits MC are, as can be seen from the drawing, connected to the U-phase winding, the V-phase winding, and the W-phase winding, respectively.

The sub-circuits SC are connected to the sets of the main switches M1u and M2u, the main switches M1v and M2v, and the main switches M1w and M2w of the main circuits MC, respectively. The sub-circuits SC are identical in structure with each other. Specifically, each of the sub-circuits SC, like in the first embodiment, includes the sub-switches S1 to S4 and the snubber capacitor 18. The operational relations of the main switches M1u and M2u to the sub-switches S1 to S4 of a corresponding one of the sub-circuits SC, the operational relations of the main switches M1v and M2v to the sub-switches S1 to S4 of a corresponding one of the sub-circuits SC, and the operational relations of the main switches M1v and M2v to the sub-switches S1 to S4 of a corresponding one of the sub-circuits SC are each identical with those of the main switches M1 and M2 to the sub-switches S1 to S4 in the first embodiment, and explanation thereof in detail will be omitted here.

The converter control system of the eighth embodiment will be described below which is a modification of the first embodiment.

FIG. 12 shows a converter CV of the eighth embodiment. The same reference numbers as employed in the above embodiments refer to the same parts, and explanation thereof in detail will be omitted here.

The main circuit MC of the converter CV, as can be seen from the drawing, includes some of the parts of the main circuit MC of the first embodiment which are used only in the power running mode for the motor-generator 10. Specifically, the main circuit MC of this embodiment does not include the main switch M1 and works as a step-up chopper circuit. This structure permits the current to flow only in one direction when the capacitor 18 is charged or discharged. The sub-circuit SC, therefore, does not include the sub-switches S2 and 83, in other words, has the diodes Ds2 and Ds3 without parallel connections with the sub-switches S2 and S3 between the input terminals T1 and T2 and the output terminals T3 and T4 of the converter CV.

The converter control system of the ninth embodiment will be described below which is a modification of the first embodiment.

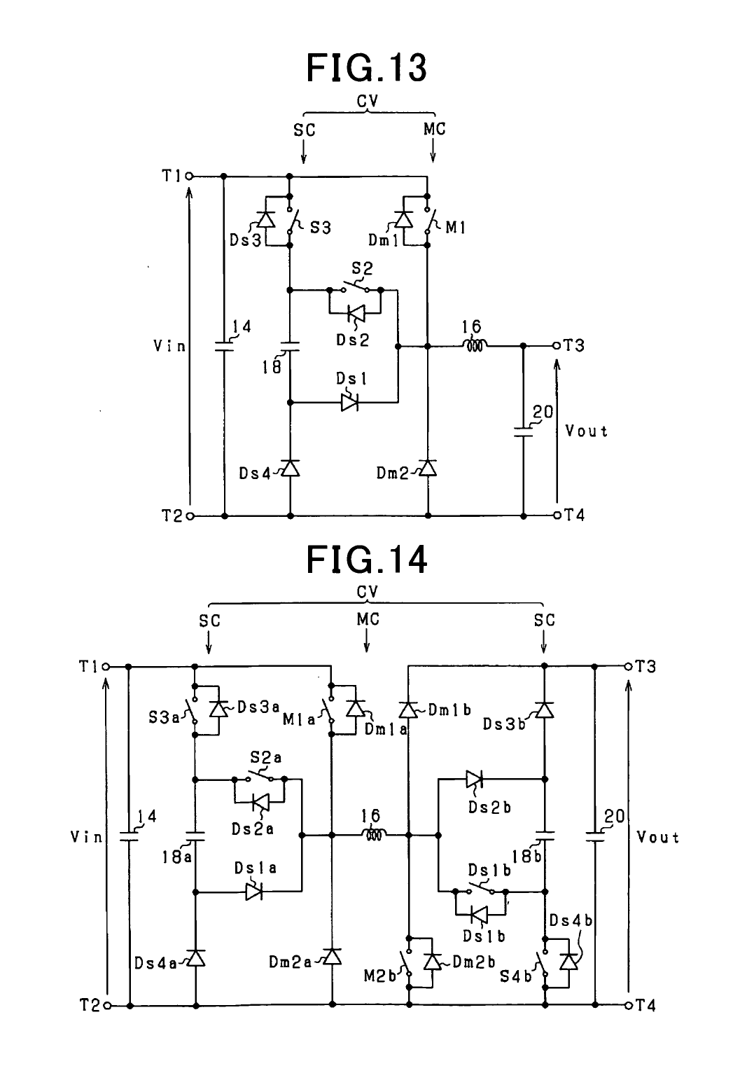

FIG. 13 shows a converter CV of the ninth embodiment. The same reference numbers as employed in FIG. 1 refer to the same parts, and explanation thereof in detail will be omitted here.

The main circuit MC of this embodiment is made up of some of the parts of the one in the first embodiment which are used only in the power running mode for driving the motor-generator 10. Specifically, the main circuit MC of this embodiment does not include the main switch M2 and works as a step-down chopper circuit. This structure permits the current to flow only in one direction when the capacitor 18 is charged or discharged. The sub-circuit SC, therefore, does not include the sub-switches S1 and S4, in other words, has the diodes Ds1 and Ds4 without parallel connections with the sub-switches S1 and S4. Unlike the first embodiment, the inductor 16 is disposed closer to the capacitor 20 than to the capacitor 14. The sub-switch S3 is disposed closer to the capacitor 14 than to the capacitor 20. Other arrangements are identical with those in the first embodiment, and explanation thereof in detail will be omitted here.

The converter control system of the tenth embodiment will be described below which is a modification of the fifth embodiment of FIG. 9.

FIG. 14 shows a converter CV of the tenth embodiment. The same reference numbers as employed in the fifth embodiment refer to the same parts, and explanation thereof in detail will be omitted here.

The main circuit MC of this embodiment is made up of some of the parts of the one in the fifth embodiment which are used only in the power running mode for driving the motor-generator 10. Specifically, the main circuit MC of this embodiment does not include the main switches M2a and M1b. This structure permits the current to flow only in one direction when the capacitor 18 is charged or discharged. The sub-circuit SC, therefore, does not include the sub-switches S1a, S4a, S2b, and S3b, in other words, has the diodes Ds1a, Ds4a, Ds2b, and Ds3b without parallel connections with the sub-switches the sub-switches S1a, S4a, S2b, and S3b.

The converter control system of the eleventh embodiment will be described below which is a modification of the sixth embodiment.

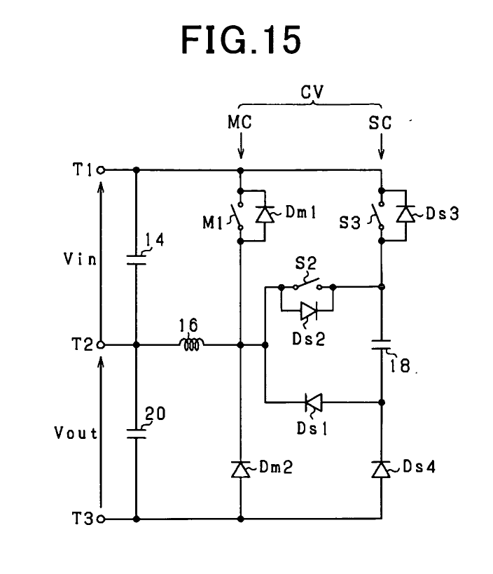

FIG. 15 shows a converter CV of the eleventh embodiment. The same reference numbers as employed in the sixth embodiment refer to the same parts, and explanation thereof in detail will be omitted here.

The main circuit MC of this embodiment is made up of some of the parts of the one in the sixth embodiment which are used only in the power running mode for driving the motor-generator 10. Specifically, the main circuit MC of this embodiment does not include the main switch M2. This structure permits the current to flow only in one direction when the capacitor 18 is charged or discharged. The sub-circuit SC, therefore, does not include the sub-switches S1 and S4, in other words, has the diodes Ds1 and Ds4 without parallel connections with the sub-switches S1 and S4.

The converter control system of the twelfth embodiment will be described below which is a combination of the first and seventh embodiments.

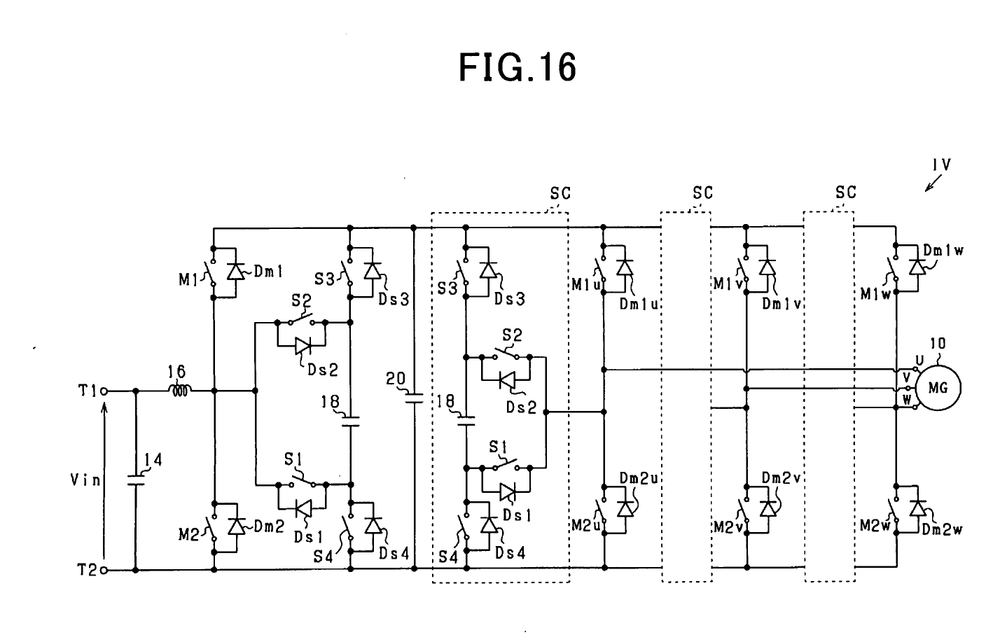

FIG. 16 shows a circuit structure of the twelfth embodiment. The same reference numbers as employed in the first and seventh embodiments refer to the same parts, and explanation thereof in detail will be omitted here.

Specifically, the converter control system consists of the converter CV of the first embodiment and the inverter IV of the seventh embodiment which are connected together. The operations of the converter CV and the inverter IV are identical with those in the first and seventh embodiment, and explanation thereof in detail will be omitted here.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set forth in the appended claims.

Either one of the main switches M1 and M2 works as a first current flow controlling component and may be each implemented by a thyristor or a photo-MOS relay as well as the IGBT or the field-effect transistor.

The first current flow controlling component needs not necessarily be disposed in inverse-parallel to diodes.

The other of the main switches M1 and M2 works as a second current flow controlling component and may be each implemented by a thyristor or a photo-MOS relay as well as the IGBT or the field-effect transistor.

The converter CV works to selectively establish a first connection state to charge the snubber capacitor 18, a second connection state to discharge the snubber capacitor 18, and a third connection state other than the first and second connection states through a switching circuit, but may alternatively be designed to switch only between the first and second connection states.

The sub-switches S1 to S4 work as sub-current flow controlling components and may be implemented by a thyristor or a photo-MOS relay as well as the IGBT or the field-effect transistor. In the case where the sub-current flow controlling components are designed to perform an open/close function to selectively open and close a circuit path extending therethrough, diodes need not necessarily be disposed in inverse-parallel to the sub-current flow controlling components.

The switching among the first connection state, the second connection state, and the third connection state are performed cyclically by a cyclic switching performing means. However, when the converter CV is in the power running mode of the first embodiment, the first connection state in which the snubber capacitor 18 is connected in parallel to the main switch M2 may be established in the third operation state and the fourth operation state wherein the main switch M2 is turned off or opened, while the second connection state in which the snubber capacitor 18 is connected in parallel to the main switch M1 may be established simultaneously with turning on of the main switch M2. Similarly, when the converter CV is in the power running mode of the first embodiment, the second connection state in which the snubber capacitor 18 is connected in parallel to the main switch M1 may be established in the seventh operation state and the eighth operation state wherein the main switch M2 is turned off or opened, while the first connection state in which the snubber capacitor is connected in parallel to the main switch M2 may be established simultaneously with turning on of the main switch M2.

The capacitance of the capacitor 18 is, as described above, to be varied by a capacitance varying means including the sub-switches SS and S6 in the second or third embodiment. Instead of the sub-switches S5 and S6, a single switch which is not equipped with a parasitic diode and can be reverse biased may be used

### Control at Low Current

When the current flowing through the inductor 16 is small, the converter CV may work in operation modes other than the above control modes. For example, the converter CV may be designed to decrease a switching frequency of the main switches M1 and M2. This will result in an increase in amount of energy stored in the inductor 16. Such an amount of energy may be made to be greater than the amount of energy charged in the snubber capacitor 18 when the voltage at the snubber capacitor 18 is elevated up to, for example, the output voltage Vout.

The converter CV of the fourth embodiment selects one of the operation state D and the operation state B depending upon whether the voltage at the snubber capacitor 18 is greater than or equal to half the output voltage Vout or not, but such selection may be made based on whether the voltage at the snubber capacitor 18 is greater than or equal to a third of the output voltage Vout or not.

In each of the first to fourth embodiments, the high voltage battery 12 may be connected close to the capacitor 20 to make the converter CV work as a step-down converter.

In the circuit structure of FIG. 16, a plurality of inverters may be coupled to the output terminals of the converter CV. Motor generators may be connected one to each of the inverters.

The converter CV, as described above, is used to transmit the power between the motor generator 10 and the high-voltage battery 12, but may alternatively be disposed between an electric motor mounted in an automotive electrically-assisted power steering device and the battery 12 or employed for an uninterruptible power source installed in, for example, buildings.

What is claimed is:

1. A power converter apparatus comprising:
a high-potential terminal and a low-potential terminal of a converter circuit to which voltage is to be applied;
a first current flow controlling component which performs an open/close function to selectively open and close a current flow path extending between the high-potential terminal and the low-potential terminal;
a second current flow controlling component which is connected in series with the first current flow controlling component between the high-potential terminal and the low-potential terminal, the second current flow controlling component performing one of an open/close function and a rectifying function, the open/close function being to selectively open and close the current flow path extending between the high-potential terminal and the low-potential terminal of the converter circuit, the rectifying function being to permit an electrical current to flow in only one direction;
an inductor connected to a joint of the first current flow controlling component and the second current flow controlling component;
a capacitor disposed between the high-potential terminal and the low-potential terminal of the converter circuit; and
a switching circuit which switches between a first connection state and a second connection state, the first connection state being to connect a first and a second terminal of the capacitor to a high-potential terminal and a low-potential terminal of the first current flow controlling component, respectively, the second connection state being to connect the first and the second terminal of the capacitor to a high-potential terminal and a low-potential terminal of the second current flow controlling component, respectively.

2. A power converter apparatus as set forth in claim 1, wherein the switching circuit works to switch among the first connection sate, the second connection state, and a third connection state which does not the capacitor in parallel connection with both the first and second current flow controlling components.

3. A power converter apparatus as set forth in claim 1, further comprising open/close operating means for opening and closing the first current flow controlling component in a cycle, and cyclic switching performing means for performing switching between the first and second connection states in every state switching cycle that corresponds to two cycles in each of which the first current flow controlling component is closed and opened sequentially, and wherein the cyclic switching performing means establishes the first connection state in a period of time in which the first current flow controlling component is placed in a closed state for the first time within the state switching cycle and also establishes the second connection state in a period of time in which the first current flow controlling component is placed in the closed state for the second time within the state switching cycle.

4. A power converter apparatus as set forth in claim 3, wherein the switching circuit works to switch among the first connection state, the second connection state, and a third connection state which does not place the capacitor in parallel connection with both the first and second current flow controlling components, and wherein the cyclic switching performing means performs, in sequence, a first switching mode, a second switching mode, a third switching mode, and a fourth switching mode, the first switching mode being entered to establish the first connection state after the first current flow controlling component is placed in the closed state for the first time within the state switching cycle, the second switching mode being entered to establish the third connection state after the first current flow controlling component is placed in an open state for the first time within each state switching cycle, the third switching mode being entered to establish the second connection state after the first current flow controlling component is placed in the closed state for the second time within the state switching cycle, the fourth switching mode being entered to establish the third connection state after the first current flow controlling component is placed in the open state for the second time within the state switching cycle.

5. A power converter apparatus as set forth in claim 1, further comprising capacitance varying means for varying a capacitance of the capacitor and capacitance controlling means for controlling an operation of the capacitance varying means to decrease the capacitance of the capacitor when an electrical current flowing through the inductor is smaller than a given value.

6. A power converter apparatus as set forth in claim 3, wherein the cyclic switching performing means includes inhibiting means for inhibiting the first connection state from being entered while establishing the second connection state upon switching of the first current flow controlling component to the open state under condition that a voltage charged in the capacitor is greater than or equal to half a voltage developed between the high-potential terminal and the low-potential terminal of the converter circuit, the inhibiting means also inhibiting the second connection state from being entered while establishing the first connection state upon switching of the first current flow controlling component to the open state under condition that the voltage charged in the capacitor is smaller than half the voltage developed between the high-potential terminal and the low-potential terminal of the converter circuit.

7. A power converter apparatus as set forth in claim 1, wherein the switching circuit includes a first sub-current flow controlling component, a second sub-current flow controlling component, a third sub-current flow controlling component, and a fourth sub-current flow controlling component, each of which performs one of an open/close function and a rectifying function, the open/close function being to selectively open and close a current flow path extending therethrough, the rectifying function being to permit an electrical current to flow in only one direction, the first sub-current flow controlling component being disposed between the joint of the first current flow controlling component and the second current flow controlling component and the second terminal of the capacitor, the second sub-current flow controlling component being disposed between the joint of the first current flow controlling component and the second current flow controlling component and the first terminal of the capacitor, the third sub-current flow controlling component being disposed between the first terminal of the capacitor and the high-potential terminal of the converter circuit, the fourth sub-current flow controlling component being disposed between the second terminal of the capacitor and the low-potential terminal of the converter circuit.

8. A power converter apparatus as set forth in claim 7, wherein the converter circuit serves to output electric power from the inductor to the high-potential terminal thereof, wherein the first and fourth sub-current flow controlling components each have the open/close function, wherein the second sub-current flow controlling component has the rectifying function to permit the current to flow only from the joint to the capacitor, and wherein the third sub-current flow controlling component has the rectifying function to permit the current to flow only from the first terminal of the capacitor to the high-potential terminal of the converter circuit.

9. A power converter apparatus as set forth in claim 8, wherein the converter circuit serves to output no electric power from the high-potential terminal thereof to the inductor, and wherein the second sub-current flow controlling component and the third sub-current flow controlling component are each implemented by a diode.

10. A power converter apparatus as set forth in claim 7, wherein the converter circuit serves to output electric power from the high-potential terminal thereof to the inductor, wherein the second and third sub-current flow controlling components each have the open/close function, wherein the first sub-current flow controlling component has the rectifying function to permit the current to flow only from the capacitor to the joint, and wherein the fourth sub-current flow controlling component has the rectifying function to permit the current to flow only from the low-potential terminal of the converter circuit to the second terminal of the capacitor.

11. A power converter apparatus as set forth in claim 10, wherein the converter circuit serves to output no electric power from the inductor to the high-potential terminal thereof, and wherein the first sub-current flow controlling component and the fourth sub-current flow controlling component are each implemented by a diode.

12. A power converter apparatus as set forth in claim 7, wherein the converter circuit serves to output electric power selectively from the high-potential terminal thereof to the inductor and from the inductor to the high-potential terminal thereof, and wherein each of the first sub-current flow controlling component, the second sub-current flow controlling component, the third sub-current flow controlling component, and the fourth sub-current flow controlling component has the open/close function.
